(19) United States
(12) Patent Application Publication
(10) Pub. No.: US 2015/0067577 A1
(43) Pub. Date: Mar. 5, 2015

(54) Covered Image Projecting Method and Portable Electronic Apparatus Using the Same

(71) Applicant: Acer Inc., New Taipei City (TW)

(72) Inventors: Chien-Hung Li, New Taipei City (TW); Yueh-Yarng Tsai, New Taipei City (TW); Yu-Hsuan Shen, New Taipei City (TW)

(73) Assignee: Acer Inc., New Taipei City (TW)

(21) Appl. No.: 14/203,723

(22) Filed: Mar. 11, 2014

(30) Foreign Application Priority Data
Aug. 28, 2013 (TW) 102130780

(51) Int. Cl. G06F 3/0481

(52) U.S. Cl. CPC G06F 3/04812
USPC 715/780

(57) ABSTRACT

A covered image projecting method for a portable electronic apparatus is disclosed. The method comprises the follow steps: displaying an input area in a display field; determining whether a position of an input cursor in the display field is covered by the input area; if the position of the input cursor in the display field is covered by the input area, capturing a local area image around the position of the input cursor; and projecting the local area image in the display field.

### BACKGROUND OF THE INVENTION

1. Field of the Invention

The present invention relates to a covered image projecting method, and more particularly, to a covered image projecting method for displaying a local area image covered by the input area. The present invention also provides a portable electronic apparatus using the covered image projecting method.

2. Description of the Related Art

Portable electronic devices such as smart phones and tablet PCs are indispensable tools for most people in daily life. These portable electronic devices do not have physical keyboards and instead use virtual keyboards or handwriting areas, thereby allowing users to input text or commands by touch, click, or slide movements. When a user clicks on the screen for inputting text in an app, an input cursor appears at the clicked position, and the virtual keyboard or handwriting area is automatically enabled and appears on the screen. Generally the enabled virtual keyboard or handwriting area occupies up to one third or even half of the display field to provide convenient operation or a clear view for clicking or writing on the display field.

However, sometimes the input area in the display field may cover the position of the input cursor. In this case, although the user can continue to input text, he/she cannot see the inputted text as it is being inputted unless the input area is turned off, which is inconvenient to the user. Although the user can move the app interface or the input area away to uncover the input cursor, it is not convenient for the user to do so in actual operations. Therefore, it is necessary to solve the problem of the virtual keyboard covering the input cursor to give the user a better view of the inputted text.

### SUMMARY OF THE INVENTION

It is an object of the present invention to provide a covered image projecting method to display a local area image covered by an input area.

To achieve the above object, the present invention provides a covered image projecting method for a portable electronic apparatus. The method comprises the following steps: displaying an input area in a display field; determining whether a position of an input cursor in the display field is covered by the input area; if the position of the input cursor in the display field is covered by the input area, capturing a local area image around the position of the input cursor; and projecting the local area image in the display field.

The present invention also provides a portable electronic apparatus using the covered image projecting method. The portable electronic apparatus comprises a display module, a field detecting module, a field capturing module, and a field projecting module. The display module displays a display field; the field detecting module determines whether a position of an input cursor in the display field is covered by an enabled input area; the field capturing module captures a local area image around the position of the input cursor when the position of the input cursor is covered by the input area; and the field projecting module projects the local area image in the display field.

Therefore, when the user is inputting text, even if the position of the input cursor is covered by the enabled input area, the user can still see the inputted text as it is being inputted because the covered image projecting method projects the image of the local area around the input cursor in the display field.

### BRIEF DESCRIPTION OF THE DRAWINGS

FIG. 1 illustrates a system block diagram of a portable electronic apparatus using the covered image projecting method of the present invention;

FIG. 2 illustrates a flow chart of the covered image projecting method of the present invention;

FIG. 3A illustrates a view of a first position and a second position in the display field;

FIG. 3B illustrates a view of clicking to input text at the first position in FIG. 3A in the present invention;

FIG. 4A illustrates a view of clicking to input text at the second position in FIG. 3A in the present invention;

FIG. 4B illustrates a view of changing the local area image after the position of the input cursor moves; and

FIG. 5 illustrates a flow chart of a covered image projecting method in another embodiment of the present invention.

### DETAILED DESCRIPTION OF THE PREFERRED EMBODIMENT

The advantages and innovative features of the invention will become more apparent from the following detailed description when taken in conjunction with the accompanying drawings.

Please refer to a system block diagram of a portable electronic apparatus 10 using the covered image projecting method of the present invention. The covered image projecting method of the present invention can be applied to the portable electronic apparatus 10, such as smart phones, tablet PCs, notebook PCs, or any other portable electronic apparatus supporting touch panel input functions.

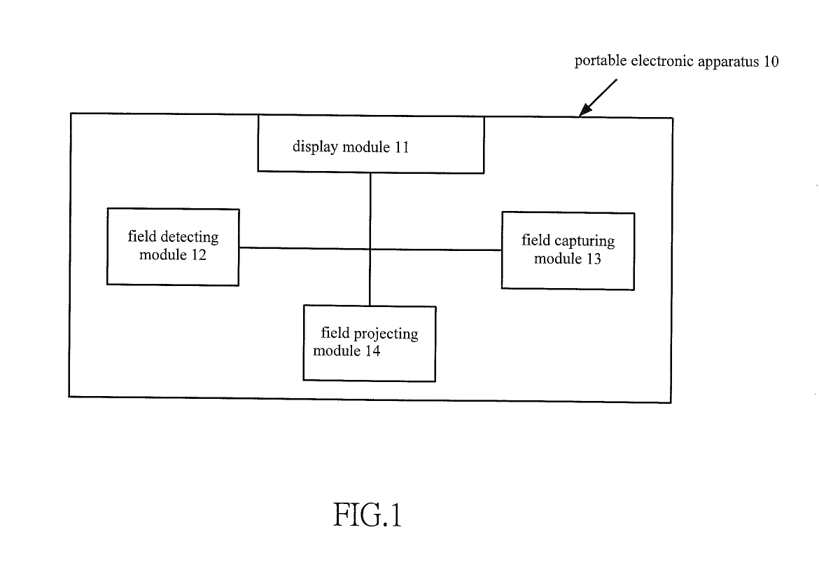

As shown in FIG. 1, the portable electronic apparatus 10 comprises a display module 11, a field detecting module 12, a field capturing module 13, and a field projecting module 14, wherein the display module 11 is electrically connected with other modules. In an embodiment of the present invention, the display module 11 can be a display panel with touch functions; the field detecting module 12, the field capturing module 13, and the field projecting module 14 can be system tools, applications, or hardware chips for carrying out specific functions; or the modules can be a combination of hardware, software, and firmware, or any two of them.

In addition, the portable electronic apparatus 10 further comprises a processing unit and a storage unit (not shown in figure). The processing unit (such as a central processing unit, CPU) issues commands to execute the operating system or application programs stored in the storage unit (such as a memory or hard drive) and displays a corresponding display field via a display module 11, wherein the display field shows a system interface of the operating system or a program interface of the application program. In an embodiment of the present invention, the operating system can be a version of Microsoft Windows (such as Windows 8) or any other operating system. The processing unit and the storage unit are known in the art and will not be further described.

The field detecting module 12 determines whether a position of an input cursor is covered by the enabled input area (such as a virtual keyboard or a blank handwriting area). The field detecting module 12 can detect a state of the display field in real time, verify the position of the input cursor, and determine whether the input cursor is covered by the input area after the input area is turned on (enabled). In an embodiment of the present invention, the field detecting module 12 can use the coordinate of every pixel on the display field to obtain a corresponding coordinate of the position of the input cursor and the range of coordinates of the input area for comparison, thereby determining whether the position of the input cursor is covered by the enabled input area; however, the present invention can use other methods to make the determination. The field capturing module 13 can determine whether to capture the local area image around the position of the input cursor according to the determined result of the field detecting module 12. When position of the input cursor is covered by the input area, the field capturing module 13 captures the local area image around the position of the input cursor such that the captured local area image comprises the position of the input cursor.

In order to keep the position of the input cursor in the local area image as the user continues to input text, the field capturing module 13 captures new local area images to correspond to new positions of the input cursor as the input cursor moves; in other words, the local area image changes when the position of the input cursor moves, and the position of the input cursor always stays in the same position within the local area image.

The field projecting module 14 projects the local area image into the display field. The field projecting module 14 updates the projected local area image according to the local area image captured by the field capturing module 13, thereby displaying new content based on the inputted text in real time.

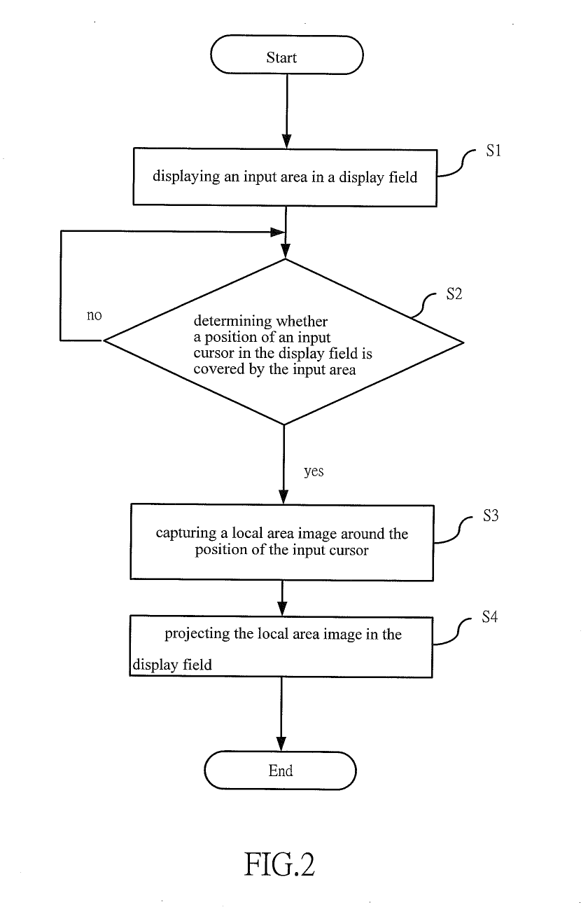

Please refer to FIG. 2 for a flow chart of the covered image projecting method of the present invention. It is noted that although the present invention illustrates the covered image projecting method with the portable electronic apparatus 10 shown in FIG. 1, the present invention can be applied in any other portable electronic apparatus having a similar structure or function. In FIG. 2, the covered image projecting method comprises steps S1 to S4 and is described below.

Step S1: displaying an input area in a display field.

When the user clicks a position in the system interface or an app interface (such as a file folder or a file name block, a text content, or any text input block), an input cursor is shown at the position to help the user confirm the text input position. At this time, the system determines that the user wants to input text, and the system turns on the input area in the display field for allowing the user to input text.

Step S2: determining whether a position of the input cursor in the display field is covered by the input area.

After the input area is turned on, the field detecting module 12 determines whether the position of the input cursor is covered by the input area. If the position of the input cursor is covered by the input area, then the covered image projecting method goes to step S3; if the position of the input cursor is not covered by the input area, then the display field stays in the same state, and the covered image projecting method continues to execute step S2 to detect the position of the input cursor relative to the input area.

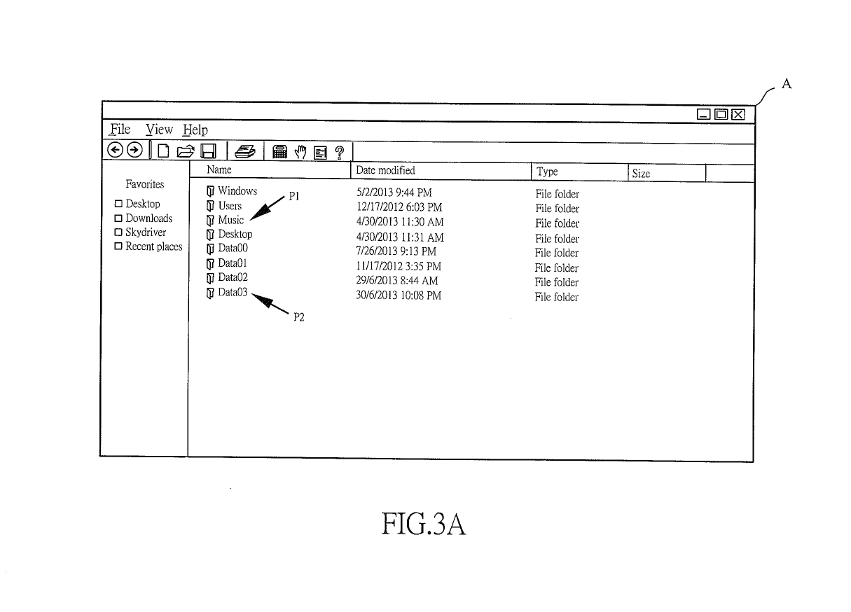

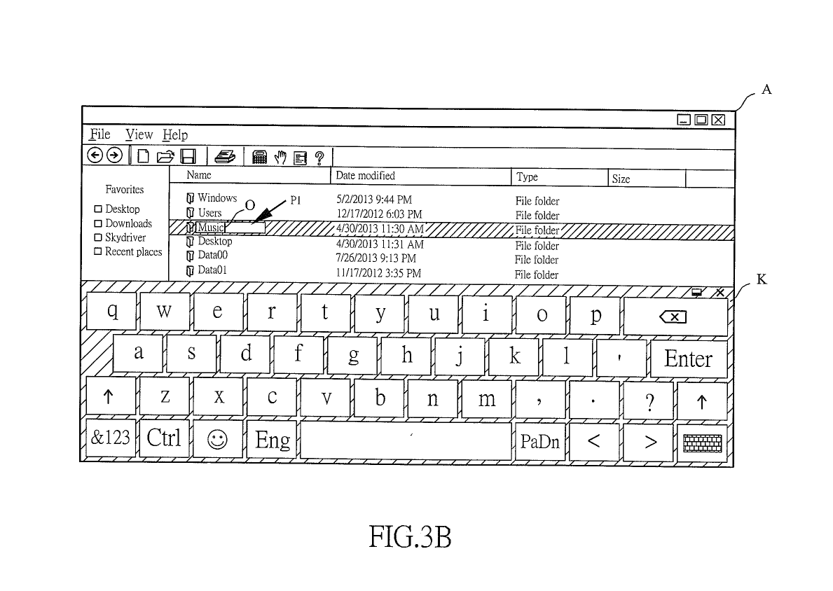

Please now refer to FIG. 3A and FIG. 3B. FIG. 3A illustrates a view of a first position P1 and a second position P2 in the display field A; FIG. 3B illustrates a view of clicking to input text at the first position P1 in FIG. 3A in the present invention. As shown in FIG. 3A, suppose that the display field A shows a file managing interface; when a user wants to modify a name of a file folder in the file managing interface, he/she can click on the name of the file folder to enable the input cursor. In the following, the covered image projecting method will be illustrated with reference to the first position P1 and the second position P2 in FIG. 3A.

As shown in FIG. 1, FIG. 3A, and FIG. 3B, when the user clicks on the first position P1 in FIG. 3A to modify the name of the file folder “Music”, the field detecting module 12 determines that the input area K does not cover the position of the input cursor O; in other words, the input cursor O is directly shown in the display field A for the user to see the current input status, and the field detecting module 12 will continue to detect the display field A.

Step S3: capturing the local area image around the position of the input cursor.

When it is determined that the position of the input cursor in the display field is covered by the input area in step S2, the field capturing module 13 uses the position of the input cursor as a reference point to capture the local area image around the position of the input cursor. In an embodiment of the present invention, the field capturing module 13 uses the position of the input cursor as a central position to capture the local area image in a predefined area (such as a rectangular area); i.e., the local area image is centered on the position of the cursor. In other embodiments of the present invention, the position of the input cursor can be located near one side of the display field, and the local image area can be in any shape.

Step S4: projecting the local area image in the display field.

The field projecting module 14 projects the local area image captured by the field capturing module 13 in step S3 in the display field, thereby allowing the user to see the text input status around the position of the input cursor.

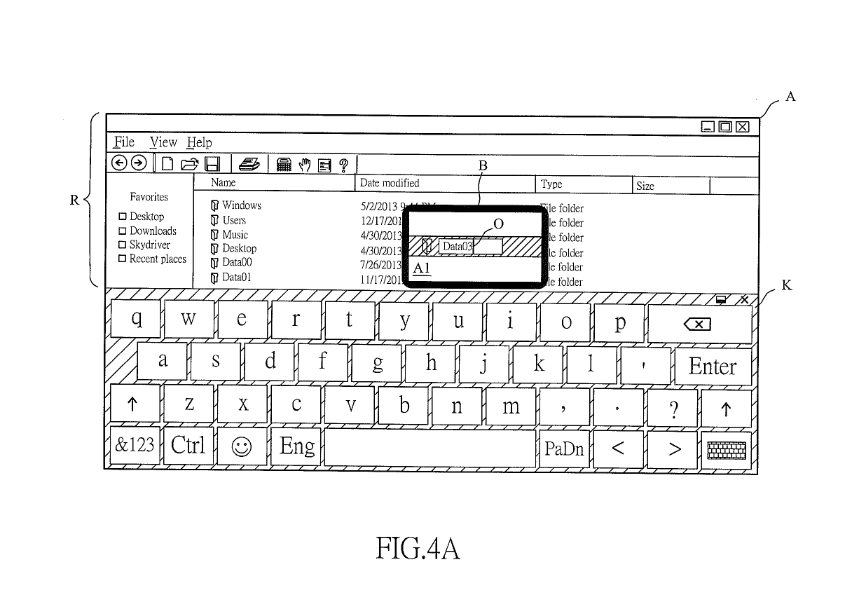

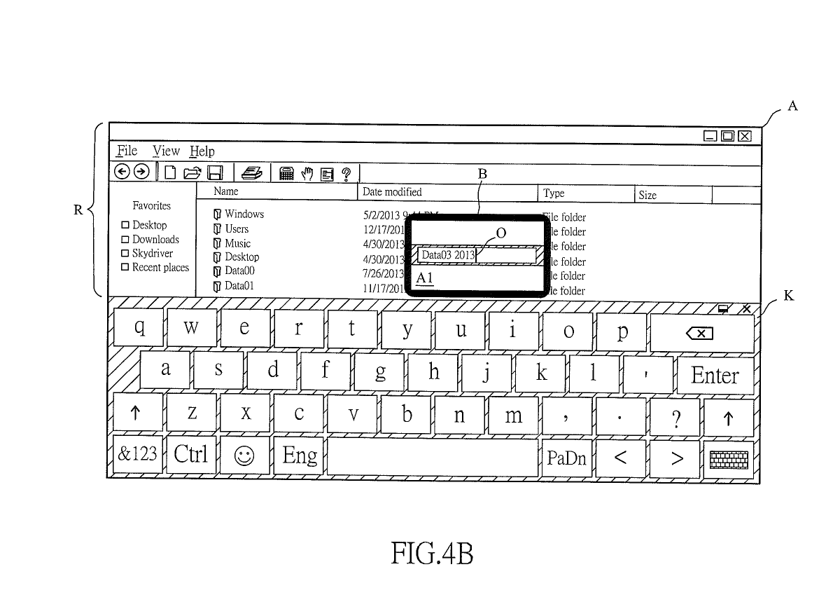

Please now refer to FIG. 4A and FIG. 4B. FIG. 4A illustrates a view of clicking to input text at the second position P2 in FIG. 3A in the present invention; FIG. 4B illustrates a view of changing the local area image A1 after the position of the input cursor O moves.

As shown in FIG. 1, FIG. 3A, and FIG. 4A, in an embodiment of the present invention, when the user clicks on the second position P2 in FIG. 3A to modify the name of the file folder “Data03”, the position of the input cursor O is covered by the input area K, so the field capturing module 13 captures the local area image A1 around the input cursor O and the field projecting module 14 projects the local area image A1 in the display field A. At this time, the field projecting module 14 will generate a projected area image B to display the local area image, wherein the projected area image B is projected in the remaining area R, defined as any area of the display other than the input area K in the display field A (such as above the input area K) to prevent the projected area image B from covering the input area K and from affecting the operation of the user. The input cursor O is located in the center position of the local area image A1.

Also shown in FIG. 1 and FIG. 4B is that when the input cursor O moves with the text inputted by the user (such as adding or deleting text), the field capturing module 13 will capture a new local area image, which is projected by the field projecting module 14 in the projected area image B. Therefore, the local area image A1 changes when the position of the input cursor O moves such that the local area image A1 is centered on the input cursor O.

In addition, the covered image projecting method further comprises step S5: turning off the local area image.

When the field detecting module 12 determines that the position of the input cursor is no longer covered by the input area (for example, the user changes the position of the input cursor, or the cursor moves out of the area covered by the input area), which means the user can see the position of the input cursor directly in the display field, then the field detecting module 12 will notify the field projecting module 14 to turn off the local area image. Also, when the user has finished inputting text, the local area image will be turned off as well. For example, when the input area is turned off, the input cursor cannot be covered by the input area, so the field projecting module 14 can turn off the local area image along with the input area; in addition, when the user has finished inputting text (e.g., when the user presses OK to finish an input operation), the input cursor in the display field will disappear, and the local area image can be turned off without further notice.

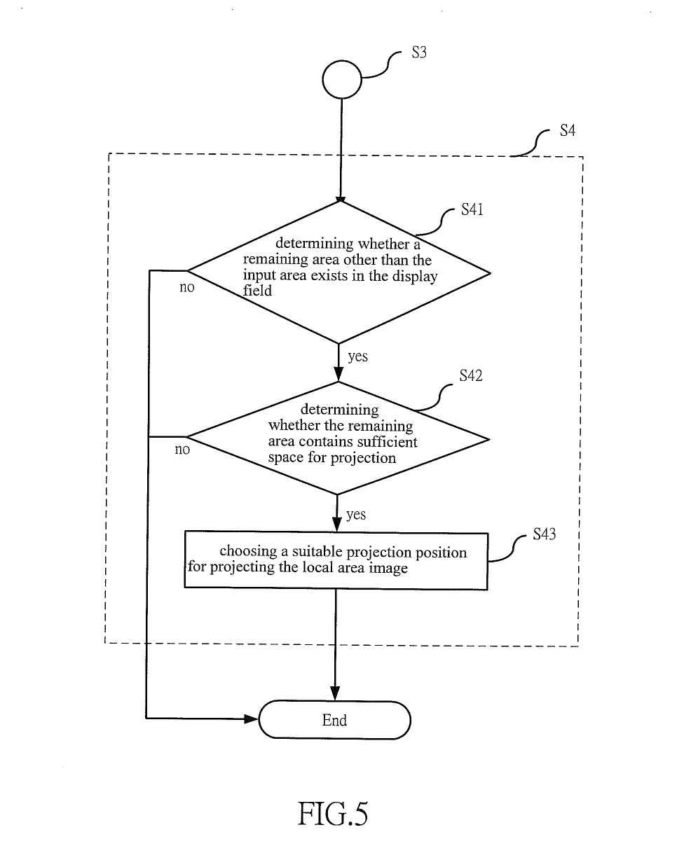

Please refer to FIG. 5 for a flow chart of the covered image projecting method in another embodiment of the present invention. As shown in FIG. 5, in this embodiment of the present invention, the covered image projecting method further comprises steps S41 to S43. These steps will be described below.

Step S41: determining whether a remaining area other than the input area exists in the display field.

When a local area image is projected in the display field, it is necessary to prevent the local area image from covering the input area; meanwhile, when the input area takes up the whole display field or the resolution of the display field is low, it is impossible to project the local area image in the display field. In such a case, after the local area image is captured in step S3, the field detecting module 12 will detect the display field and the enabled input area in advance to determine whether a remaining area for projecting the local area image other than the input area exists in the display field.

Step S42: determining whether the remaining area contains sufficient space for projection.

If the remaining area exists in the display field, then the field detecting module 12 determines whether the remaining area contains sufficient space for projection. The local area image is projected in the display field to help the user confirm the current text input status, so the local area image should be large or clear enough for the user. Hence, the field detecting module 12 determines whether the remaining area has enough room for projecting the local area image, wherein the field detecting module 12 makes the decision according to different user settings.

For example, as shown in FIG. 4A, it is necessary for the remaining area R to contain enough space to display the whole of the projected area image B; if the remaining area R is smaller than the projected area image B, then it is determined that the remaining area R does not have enough space.

Step S43: choosing a suitable projection position in the remaining area for projecting the local area image.

When it is determined that the remaining area contains sufficient projection space, the field detecting module 12 notifies the field projecting module 14, and then the field projecting module 14 chooses a suitable projection position in the remaining area to project the local area image. For example, in FIG. 4A, the projected position of the projected area image B should be set as close to the center position of the display field as possible for a better viewing effect; however, the projected position can be set at anywhere else in the remaining area of the display field.

In the present invention, even if the position of the input cursor is covered by the input area when the user is inputting text, the portable electronic device can still display the local area image of an area containing the input cursor such that the user can see the text being inputted without being affected by the enabled input area, thereby providing a more convenient method for inputting and displaying text.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A covered image projecting method for a portable electronic apparatus, the method comprising the following steps:
displaying an input area in a display field;
determining whether a position of an input cursor in the display field is covered by the input area;
if the position of the input cursor in the display field is covered by the input area, capturing a local area image around the position of the input cursor; and
projecting the local area image in the display field.

2. The method as claimed in claim 1, wherein the local area image is centered on the position of the input cursor.

3. The method as claimed in claim 2, wherein the local area image changes when the position of the input cursor moves.

4. The method as claimed in claim 1, wherein the local area image is turned off when the input area is turned off or the input cursor disappears.

5. The method as claimed in claim 1, wherein when it is determined that the position of the input cursor is not covered by the input area, the local area image is turned off.

6. The method as claimed in claim 1 further comprising the following steps:
determining whether a remaining area other than the input area exists in the display field;
if the remaining area exists in the display field, determining whether the remaining area contains sufficient space for projection; and
if the remaining area contains sufficient space for projection, choosing a suitable projection position for projecting the local area image.

7. A portable electronic apparatus comprising:
a display module for displaying a display field;
a field detecting module for determining whether a position of an input cursor in the display field is covered by an enabled input area;
a field capturing module for capturing a local area image around the position of the input cursor when the position of the input cursor is covered by the input area; and
a field projecting module for projecting the local area image in the display field.

8. The portable electronic apparatus as claimed in claim 7, wherein the local area image is centered on the position of the input cursor.

9. The portable electronic apparatus as claimed in claim 7, wherein the field capturing module captures the local area image again when the position of the input cursor moves.

10. The portable electronic apparatus as claimed in claim 7, wherein the field projecting module turns off the local area image when the input area is turned off or the input cursor disappears.

11. The portable electronic apparatus as claimed in claim 7, wherein when the field detecting module determines that the position of the input cursor is not covered by the input area, the field projecting module is notified to turn off the local area image.

12. The portable electronic apparatus as claimed in claim 7, wherein the field detecting module determines whether a remaining area other than the input area exists in the display field; if the remaining area exists in the display field, the field detecting module chooses a suitable projection position in the remaining area for projecting the local area image when the field detecting module determines the remaining area contains sufficient space for projection.
